(19) United States
(12) Patent Application Publication
(10) Pub. No.: US 2023/0238230 A1
(43) Pub. Date: Jul. 27, 2023

(54) MASS ANALYSIS

(71) Applicant: DH TECHNOLOGIES DEVELOPMENT PTE. LTD., Singapore (SG)

(72) Inventors: Thomas R. COVEY, Concord, Ontrario (CA); Chang LIU, Concord, Ontrario (CA)

(21) Appl. No.: 17/999,814

(22) PCT Filed: May 25, 2021
(86) PCT No.: PCT/IB2021/000352

§ 371 Date: Nov. 23, 2022

Related U.S. Application Data
(60) Provisional application No. 63/029,661, filed on May 25, 2020.

(51) Int. Cl. H01J 49/04; H01J 49/16; B25J 15/00

(52) U.S. Cl. CPC H01J 49/0413; H01J 49/165; B25J 15/0052

(57) ABSTRACT

Technology for analyzing collections of substance samples. Systems in accordance with the disclosure can include one or more sample handlers, sample capture devices, mass analysis instruments, and controllers; the controllers being operative, in accordance with instructions received from at least one of an operator input device and machine-interpretable instructions stored in memory accessible by the controller, to generate signals configured to cause the sample handler to collectively retrieve from a sample source a plurality of samples of one or more substances, and deliver the plurality of collected samples to the at least one sample capture device; cause the sample capture device to independently capture at least one of the collectively retrieved samples delivered by the sample handler, and transfer the at least one captured sample to a mass analysis instrument; and cause the mass analysis instrument to ionize and detect one or more particles of the transferred treated sample.

### CROSS-REFERENCE TO RELATED CASES

This application is being filed on May 25, 2021, as a PCT International Patent Application and claims the benefit of priority to U.S. Patent Application Ser. No. 63/029,661, filed May 25, 2020, the entire disclosure of which is hereby incorporated by reference in its entirety.

### FIELD

The invention relates generally to sample analysis and methods of analyzing samples, and more particularly to such analyses involving measurements through the use of mass spectrometry.

### BACKGROUND

The preparation and introduction of sample into a mass spectrometer is conventionally a relatively time-consuming process, particularly where rapid and efficient analysis of multiple samples, which may or may not be analytically related, is desired. In some areas of study, for example, it would be useful to be able to process multiple samples in quick succession, such as in high throughput screening procedures for instance. To date there has not been an effective mechanism for employing sensitive analytical mass spectrometers in high throughput screening due to the delay in sample preparation and introduction required with current techniques, particularly when analysis requires variations in processing methods.

Other areas of analysis would benefit from an improved method for sample preparation and introduction into mass spectrometers.

### SUMMARY

In various aspects and embodiments, systems and methods are provided for: receiving a plurality of samples; and, iteratively: independently capturing one of the plurality of samples, diluting and transporting the captured sample to a mass analysis instrument, mass analyzing the transported diluted sample, and repeating for at least some of the plurality of samples.

In some embodiments, the systems and methods further provide for: identifying at least one analysis instruction associated with the plurality of samples; and, performing at least one of the capturing, diluting, transporting, or mass analyzing based on the at least one analysis instruction. In some aspects, the identifying is performed by an indicia physically associated with the plurality of samples, and wherein the indicia is accessed by the system to locate the associated analysis instruction corresponding to the plurality of samples.

In some embodiments, the systems and methods further provide for a sample source supplying the plurality of samples; and, a sample handler operative to retrieve the plurality of samples from the sample source and deliver the plurality of samples to a capture location for the capturing of the samples. In some aspects, the sample source comprises a fluid handler for preparing the plurality of samples. In some aspects, the sample source comprises a sample storage device for storing multiple sets of separate plurality of samples. In the aspects the sample source and the sample handler are further operative to cooperatively select one of the sets of separate plurality of samples.

In various aspects and embodiments, systems and methods in accordance with the disclosure provide for analysis of collections of substance samples. Systems according to such aspects and embodiments can comprise at least one of each of a sample handler; a sample capture device; a mass analysis instrument; and a controller, the at least one controller being operative, in accordance with instructions received from at least one of an operator input device and machine-interpretable instructions stored in memory accessible by the controller, to generate signals configured to cause the sample handler to collectively retrieve from a sample source a plurality of samples of one or more substances, and deliver the plurality of collected samples to the at least one sample capture device; cause the sample capture device to independently capture at least one of the collectively retrieved samples delivered by the sample handler, and transfer the at least one captured sample to a mass analysis instrument; and cause the mass analysis instrument to ionize and detect one or more particles of the transferred treated sample.

In various aspects and embodiments, systems and methods in accordance with the disclosure provide for analysis of collections of substance samples. Systems according to such aspects and embodiments can comprise at least one each of a sample handler for retrieving a collection of samples from a sample source and delivering the collection of samples to a capture location; a stage device for receiving the plurality of samples at the capture location and locating a selected set of the samples in a capture position proximate to a capture probe; and a sample ejector for independently ejecting at least one of the selected set of samples into the capture surface for capture by the capture probe; the capture probe for capturing the ejected sample and diluting and transporting the captured sample to a mass analysis instrument; the mass analysis instrument being operative to ionize the transported diluted sample to produce sample ions and to filter and detect selected ions of interest from the sample ions; and, a controller operative to coordinate operation of the sample handler, stage device, sample ejector, capture probe, and mass analysis instrument.

In an aspect, the technology relates to a system for analyzing collection of substance samples. The system includes a plate handler; an ejector; a capture probe; a mass analysis instrument; and a controller operative to, in accordance with instructions stored in memory accessible by the controller, generate signals. The signals are configured to cause the plate handler to move a well plate to a capture location; cause the ejector to eject a first sample from a first well of the well plate; cause the capture probe to transport the ejected first sample to the mass analysis instrument; and cause the mass analysis instrument to ionize and detect one or more particles of the transported first sample.

In an example, the controller is further operative to generate signals configured to: cause the plate handler to adjust position a position of a plate such that a second well of the well plate is a position to be ejected; cause the ejector to eject a second sample from the second well of the well plate; cause a capture probe to transport the ejected second sample to the mass analysis instrument; and cause the mass analysis instrument to ionize and detect one or more particles of the transported second sample. In another example, the ejected sample is transported from an open-port interface to the mass analysis instrument via a conduit. In a further example, the instructions are based on an operational protocol configured via a user interface for the controller. In still another example, the system further includes a sample handler and a sample source, wherein the controller is further operative to generate signals configured to cause the sample handler to retrieve the well plate from the sample source. In yet another example, the sample handler is a robotic arm. In still yet another example, the plate handler is a movable stage.

In another example, the capture probe is configured, in accordance with signals generated by the at least one controller, to add to the first ejected sample at least one of a dilutant and a solvent, prior to transporting the first sample to the mass analysis instrument. In yet another example, the well plate is associated with an identifier interpretable by the controller and configured to enable the controller to generate signals configured for causing at least one component of the system to perform at least one sample capture, sample transfer, dilution, dissolution, or mass analysis operation specific to the sample associated with the identifier. In another example, the controller is operative to adjust at least one operational setting of the mass analysis instrument, based upon an analysis instruction associated with the at least one identifier.

In an aspect, the technology relates to a system for analyzing collections of substance samples. The system includes a first sample handler; a second sample handler; a third sample handler; an ejector; a mass analysis instrument; and a controller operative to, in accordance with instructions stored in memory accessible by the controller, generate signals. The signals are configured to cause the first sample handler to retrieve a well plate from a sample source; cause the second sample handler to transfer the retrieved well plate to an ejection system; cause the third sample handler to position the transferred well plate in a capture location; cause the ejector to eject a first sample from the well plate in the capture location; and cause the mass analysis instrument to ionize and detect one or more particles of the ejected first sample.

In an example, the controller is further operative to generate signals configured to: cause the third sample handler to move the well plate to a new position; and cause the ejector to eject a second sample from the well plate; and cause the mass analysis instrument to ionize and detect one or more particles of the ejected second sample. In another example, the first sample handler is a robotic arm. In a further example, the second sample handler is a robotic arm. In yet another example, the third sample handler is a movable plate stage. In still another example, the system further includes a machine reading device, wherein the controller is further operative to generate signals configured to cause the machine reading device to read an identifier from the well plate. In still yet another example, at least a portion of the instructions are based on the read identifier. In another example, the controller is operative to adjust at least one operational setting of the mass analysis instrument, based upon an analysis instruction associated with the at least one identifier.

The various aspects and embodiments of the invention include systems, methods, devices, components, including software, for implementing the various functions and processes described herein.

### DESCRIPTION OF DRAWINGS

Various aspects and embodiments of the invention are shown in the drawings and described therein and elsewhere throughout the disclosure. In the drawings, like references indicate like parts.

FIGS. 1-2 are schematic diagrams illustrating exemplary mass analysis systems in accordance with various aspects and embodiments of the invention.

FIG. 3 depicts a schematic view of an example system combining an acoustic droplet ejection system with a sampling interface and an ion source.

FIGS. 4-6 are schematic diagrams illustrating exemplary operator input-output interface screens generated by one or more controllers of a mass analysis system in accordance with various aspects and embodiments of the invention.

FIGS. 7A and 7B are schematic diagrams illustrating exemplary sample handing operations performed by an embodiment of a sample handler in accordance with an aspect of the invention.

FIG. 8A is a top plan view of exemplary components of a mass analysis system.

FIG. 8B is a front elevation view of the exemplary configuration shown in FIG. 8A.

FIG. 8C is a front top and right side perspective view of the exemplary configuration shown in FIG. 8A.

FIG. 8D is a front top and left side perspective view of the exemplary configuration shown in FIG. 8A.

FIG. 9 is a schematic diagram illustrating exemplary control signal exchanges between components of a mass analysis system in accordance with various aspects and embodiments of the invention.

### DETAILED DESCRIPTION

In various aspects and embodiments systems, components, and devices, and combinations thereof, are provided for analyzing substance samples, and particularly for analyzing of pluralities of substance samples.

As discussed briefly above, the preparation and introduction of sample into a mass spectrometer is conventionally a relatively time-consuming process, particularly where rapid and efficient analysis of multiple samples, which may or may not be analytically related, is desired. For instance, multiple different systems may have been used that were provided and controlled by separate entities and/or devices. For example, a liquid handling system would be used for preparation of samples, an ejection system would be used for ejecting samples into a port or interface, and mass spectrometry system would be used for the actual analysis of the samples. Each system needed to be separately controlled and operated, which led to significant challenges and inefficiencies, including requirement of manual interaction and intervention for many of the operations.

The present technology improves such technology by providing a central control system that is able to orchestrate and control the underlying subsystems used in the sample analysis process. For example, a script or set of operations may be generated at the central control system or controller that allows for control the subsystems such that the subsystems are able to work synchronously across different types of operations performed by each of the subsystems. To accomplish such synchronicity across the subsystems, additional mechanical devices, such as robotics, may be incorporated into the overall system to handle transitions of materials between the systems. Thus, the central controller is able to interface with the various subsystems and transition robotics to more efficiently control each of the operations performed by the subsystems. As a result, the throughput of the entire system may be increased.

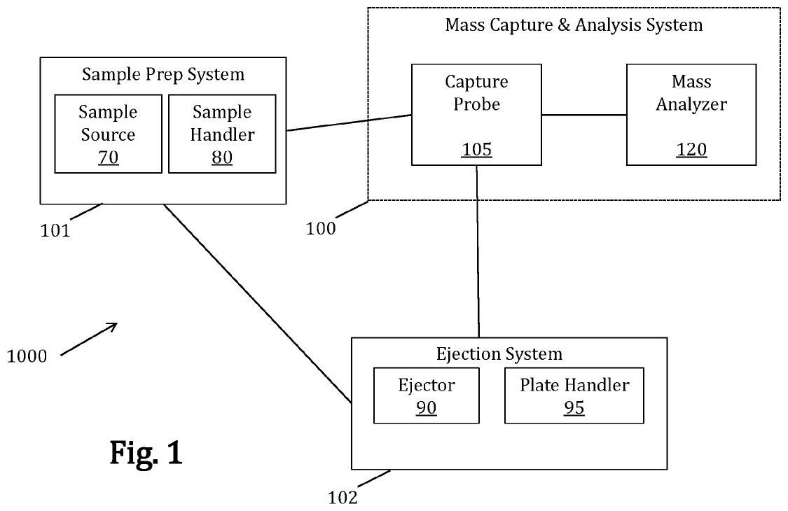

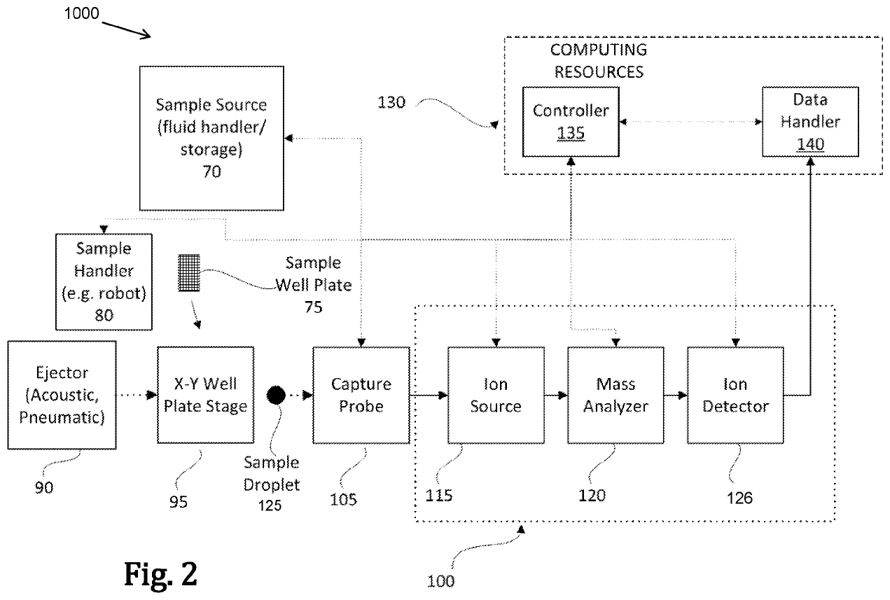

As shown for example in FIGS. 1 and 2, in various aspects and embodiments, systems 1000 in accordance with the invention can comprise, in various combinations, pluralities of components, including some or all of: one or more sample sources 70; sample handler(s) 80 for retrieving collections of samples from the sample source(s) and delivering retrieved collections to capture locations associated with sample capture devices or probes 105. The systems may be operative to independently capture selected ones of the pluralities of samples at the capture locations from the pluralities of samples, to optionally dilute the samples and to transfer the captured samples to mass analysis instruments 100, 120 for mass analysis. Computing resources 103 and/or controller 135 in the form of electronic signal processors may be operative to coordinate some or all of the operations of the pluralities of the various components.

With respect to FIG. 1, an example system 1000 may include a mass capture & analysis system 100, a sample preparation system 101, and an ejection system 102. In some examples, the mass capture & analysis system 100 may be a mass analysis instrument 100 in some examples. The mass capture & analysis system 100 includes a mass analyzer for analyzing ions generated from ionization of a sample. The mass capture and analysis system 100 may also include a capture device or probe 105 that captures the sample and provides the sample to other components of the mass capture and analysis system 100. In other examples (such as shown in FIG. 2), the capture probe 105 may be located externally from the mass analysis instrument 100. For instance, the capture probe 105 may be part of the ejection system 102.

The sample preparation system 101 may include a sample source 70 and a sample handler 80. The sample source 70 may include a set of well plates in a storage housing and/or fluid for adding to well plates. The sample source 70 may include part of a fluid handling system that manipulates and/or injects fluid into the well plates. The sample handler 80 includes one or more electro-mechanical devices (e.g., robotics, conveyor belts, stages, etc.) that are capable of transferring the samples (e.g., well plates) from the sample source to other components of the sample preparation system 101 and/or to other systems, such as the ejection system 102 and/or the capture probe 105. As an example, the sample handler 80 may transfer a well plate from the sample preparation system 101 to the ejection system 102. More specifically, the sample handler 80 may transfer the well plate to a plate handler 95 of the ejection system 102. Accordingly, the sample preparation system 101 may also be referred to as a sample delivery system.

In addition to the plate handler 95, the ejection system 102 may include an ejector 90 that ejects droplets from the wells of the well plates. The ejector 90 may be any type of suitable ejector, such as an acoustic ejector or a pneumatic ejector. In an example, the plate handler 95 receives a well plate from the sample handler 80. The plate handler 95 transports the plate to a capture location that may be aligned with the capture probe 105. Once in the capture location, the ejector 90 ejects droplets from one or more wells of the well plates. The plate handler 95 may include one or more electro-mechanical devices, such as a translation stage that translates the well plate in an x-y plane to align wells of the well plate with the ejector 90 and/or or the capture probe 105.

Turning to FIG. 2, in some aspects and embodiments, the plate handler or stage 95 is provided at the capture location; the stage for locating or placing individual samples from the collection of samples in alignment with, or in other operating proximity with respect to, a sample ejector 90 and a capture probe 105; the sample ejector operative 90 to eject one or more sample droplets 125 from the located individual sample into the capture probe 105; the capture probe 105 operative to capture, optionally dilute, and transport the sample droplets 125 to a mass analysis instrument 100 for mass analysis.

In some aspects, the system may further comprise the generation, assignment, and use of identifiers associated with collections of samples and/or individual samples, and incorporation by one or more of components 70, 80, 95, 105, 100, etc. of identifier readers. For instance, an identifier associated with a well plate may be read or scanned as it leaves the sample source 70 and/or when the well plate is received by the stage 95. In such aspects, the identifier(s) may be used by the system to associate a corresponding one or more sets of instructions for use by the mass analysis instrument 100, 120 when analyzing transported sample droplets 125. In some aspects, the identifier may comprise an indicia physically associated with the plurality of samples. In some aspects, the indicia may be readable by optical, electrical, magnetic or other non-contact reading means. Indicia or identifiers in accordance with such aspects of the disclosure can include any characters, symbols, or other devices suitable for use in adequately identifying samples, sample collections, and/or handling or analysis instructions suitable for use in implementing the various aspects and embodiments of the invention.

Additional details regarding implementation and operation of systems 1000 in accordance with various aspects and embodiments of the invention can be explained with reference to the Figures. FIGS. 1 and 2 present system diagrams illustrating embodiments of a system 1000, each embodiment including a sample handler 80 and an associated controller 135, which may be, for example, a Biomek computer available from Beckman Coulter Life Sciences, is in operative communication with a mass analysis instrument 100 and a controller for the capture probe 105, which may include, for example, an a SciexOS® or Analyst® computer available from Sciex. The Analyst® or SciexOS® computer includes a control component for the capture probe 105, represented for example by Sciex open port probe (OPP) (also referred to as an open port interface (OPI)) software, and a control component for the mass analysis instrument, which may be the Analyst® computer. The mass analysis instrument and capture probe controller may be further in operative communication with an ejector 90 and an X-Y Well Plate Stage 95 and plate handler controller, which may be, for example, an EDC liquid droplet ejector with embedded computer or processor. For the purposes of this application, these distributed controller components may collectively be considered to be a system controller, and depending upon the configuration may be centralized, or distributed as is the case here. For instance, one of the controllers or controller components may send signals to the other controllers to control the respective devices. As an example, the controller 135 may be a controller originally configured for the control of the sample preparation system 101 (e.g., sample handler 80 and/or the sample sources 70) and may be used as the primary controller for controlling components in addition to those components in the sample preparation system 101, such as the mass analysis instrument 100 and the ejection system. As another example, the controller 135 may be a controller for the mass analysis instrument 100 and may be used as the primary controller for controlling components in addition to those components housed within the mass analysis instrument 100. As such, one controller may be considered the main or central controller that orchestrates, or communicates with, the other controllers to carry out the operations discussed herein in a more efficient manner.

FIG. 2 presents an exemplary mass analysis instrument 100 according to various embodiments of the present teachings. The mass analysis instrument 100 is an electro-mechanical instrument for separating and detecting ions of interest from a given sample. The mass analysis instrument 100 may be associated with computing resources 130 operative to carry out both control of the system components and to receive and manage the data generated by the mass analysis instrument 100. In the embodiment of FIG. 2, the computing resources 130 are illustrated as having separate modules: a controller 135 for directing and controlling the system components and a data handler 140 for receiving and assembling a data report of the detected ions of interest. Depending upon requirements, the computing resources 130 may comprise more or fewer modules than those depicted, may be centralized or otherwise share processing, control, and/or memory resources, or they may be distributed across the system components depending upon requirements. Typically, a detected ion signal generated by the ion detector 126 is formatted in the form of one or more mass spectra based on control information as well as other process information of the various system components. Subsequent data analysis using a data analyzer (not illustrated in FIG. 2) may subsequently be performed on a data report (e.g. on the mass spectra) in order to interpret the results of the mass analysis performed by the mass analysis instrument 100.

Also illustrated in FIG. 2 are components of a sample delivery system for use in combination with the mass analysis instrument 100. The sample delivery system includes at least a sample source 70 for supplying a plurality of samples, a sample handler 80 for delivering the plurality of samples to a capture location, and a capture probe 105 for independently capturing one or more samples of the plurality of samples. In some aspects, the sample delivery system may further include a stage 95 for locating each sample for the plurality of samples proximate to a capture surface of the capture probe 105 and an ejector 90 for selectively ejecting that located sample into the capture surface of the capture probe.

In operation, a sample delivery system (including sample source 70 and sample handler 80) can iteratively deliver independent samples from a plurality of samples (e.g., a sample from a well of a well plate 75) to the capture probe 105. The capture probe 105 can dilute and transport each such delivered sample to the ion source 115 disposed downstream of the capture probe 105 for ionizing the diluted sample. A mass analyzer 120 can receive generated ions from the ion source 115 for mass analysis. The mass analyzer 120 is operative to selectively separate ions of interest from generated ions received from the ion source 115 and to deliver the ions of interest to an ion detector 126 that generates a mass spectrometer signal indicative of detected ions to the data handler 140. In some aspects, the separate ions of interest may be indicated in an analysis instruction associated with that sample. In some aspects, the separate ions of interest may be indicated in an analysis instruction identified by an indicia physically associated with the plurality of samples.

Computing resources 130 may comprise a single computing device or may comprise a plurality of distributed computing devices in operative communication with components of a mass analysis instrument 100. In such an example, computing resources 130 may include a bus or other communication mechanism for communicating information, and at least one processing element coupled with bus for processing information. As will be appreciated by those skilled in the relevant arts, such at least one processing element may comprise a plurality of processing elements or cores, which may be packaged as a single processor or in a distributed arrangement. Furthermore, in some embodiments, a plurality of virtual processing elements may be provided to provide the control or management operations for the mass analysis instrument 100.

Computing resources 130 may also include one or more volatile memory(ies), which can for example include random access memory(ies) (RAM) or other dynamic memory component(s), coupled to one or more busses for use by the at least one processing element. Computing resources 130 may further include static, non-volatile memory(ies), such as read only memory (ROM) or other static memory components, coupled to busses for storing information and instructions for use by the at least one processing element. A storage component, such as a storage disk or storage memory, may be provided for storing information and instructions for use by the at least one processing element. As will be appreciated, in some embodiments the storage component may comprise a distributed storage component, such as a networked disk or other storage resource available to the computing resources 130.

Computing resources 130 may be coupled to one or more displays for displaying information to a computer user. Optional user input devices, such as a keyboard and/or touchscreen, may be coupled to a bus for communicating information and command selections to the at least one processing element. An optional graphical input device, such as a mouse, a trackball or cursor direction keys for communicating graphical user interface information and command selections to the at least one processing element. The computing resources 130 may further include an input/output (I/O) component, such as a serial connection, digital connection, network connection, or other input/output component for allowing intercommunication with other computing components and the various components of the mass analysis instrument 100.

In various embodiments, computing resources 130 can be connected to one or more other computer systems a network to form a networked system. Such networks can for example include one or more private networks, or public networks such as the Internet. In the networked system, one or more computer systems can store and serve the data to other computer systems. The one or more computer systems that store and serve the data can be referred to as servers or the cloud, in a cloud computing scenario. The one or more computer systems can include one or more web servers, for example. The other computer systems that send and receive data to and from the servers or the cloud can be referred to as client or cloud devices, for example. Various operations of the mass analysis instrument 100 may be supported by operation of the distributed computing systems.

Computing resources 130 may be operative to control operation of the components of the mass analysis instrument 100 and the sample delivery components 70, 80, 95, 105 through controller(s) 135 and to handle data generated by components of the mass analysis instrument 100 through data handler(s) 140. In some embodiments, analysis results are provided by computing resources 130 in response to the at least one processing element executing instructions contained in memory and performing operations on data received from the mass analysis instrument 100. Execution of instructions contained in memory by the at least one processing element can render the mass analysis instrument 100 and associated sample delivery components operative to perform methods described herein. Alternatively, hard-wired circuitry may be used in place of or in combination with software instructions to implement the present teachings. Thus, implementations of the present teachings are not limited to any specific combination of hardware circuitry and software.

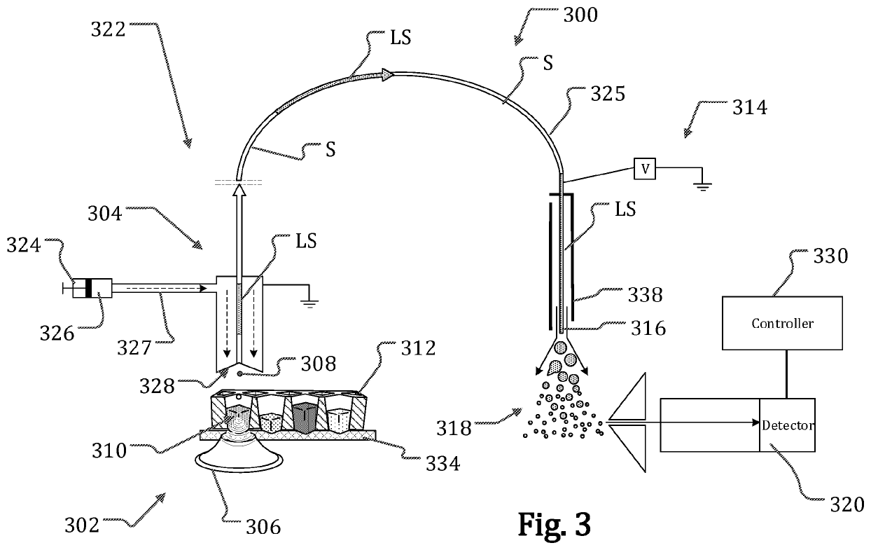

FIG. 3 depicts a schematic view of an example system 300 combining an acoustic droplet ejection (ADE) device 302 with an open port interface (OPI) 304 and an electrospray ionization (ESI) device source 314. The system 300 provides an example of an integration and physical connection between the ejection system 102, the capture probe 105, and the mass analysis instrument 100.

The ADE 302 includes an acoustic ejector 306 that is configured to eject a droplet 308 from a reservoir 312 into the open end of sampling OPI 304. The acoustic ejector 306 is one example of the ejector 90, and the sampling OPI 304 is one example of the capture probe 105. As shown in FIG. 3, the example system 300 generally includes the sampling OPI 304 in liquid communication with the ESI source 314 for discharging a liquid containing one or more sample analytes (e.g., via electrospray electrode 316) into an ionization chamber 318, and a mass analyzer detector (depicted generally at 320) in communication with the ionization chamber 318 for downstream processing and/or detection of ions generated by the ESI source 314. The ESI source 314 is an example of the ion source 115, and the mass analyzer detector 320 is an example of the ion detector 126.

Due to the configuration of the nebulizer probe 338 and electrospray electrode 316 of the ESI source 314, samples ejected therefrom are in the gas phase. A liquid handling system 322 (e.g., including one or more pumps 324 and one or more conduits 325) provides for the flow of a transport fluid or liquid from a solvent reservoir 326 to the sampling OPI 304 and from the sampling OPI 304 to the ESI source 314. The solvent reservoir 326 (e.g., containing a liquid, desorption solvent) can be liquidly coupled to the sampling OPI 304 via a supply conduit 327 through which the transport fluid or liquid can be delivered at a selected volumetric rate by the pump 324 (e.g., a reciprocating pump, a positive displacement pump such as a rotary, gear, plunger, piston, peristaltic, diaphragm pump, or other pump such as a gravity, impulse, pneumatic, electrokinetic, and centrifugal pump), all by way of non-limiting example. The flow of transport fluid or liquid into and out of the sampling OPI 304 occurs within a sample space accessible at the open end such that one or more droplets 308 can be introduced into the liquid boundary 328 at the sample tip and subsequently delivered to the ESI source 314.

The ADE 302 is configured to generate acoustic energy that is applied to a liquid contained within a well or reservoir 310 of a well plate 312 that causes one or more droplets 308 to be ejected from the reservoir 310 into the open end of the sampling OPI 304. The well plate 312 is an example of the well plates 75 discussed above. The acoustic energy is generated from an acoustic ejector 306, which is an example of the ejector 90 discussed above. The well plate 312 may reside on a movable stage 334, which is an example of the plate stage 95 discussed above.

A controller 330 can be operatively coupled to the ADE 302 and can be configured to operate any aspect of the ADE 302 (e.g., focusing structures, acoustic ejector 306, automation elements for moving a movable stage 334 so as to position a reservoir 310 into alignment with the acoustic ejector 306 and/or the OPI 304, etc.). This enables the ADE 302 to eject droplets 308 into the sampling OPI 304 as otherwise discussed herein substantially continuously or for selected portions of an experimental protocol by way of non-limiting example. Controller 330 can be, but is not limited to, a microcontroller, a computer, a microprocessor, or any device capable of sending and receiving control signals and data. Wired or wireless connections between the controller 330 and the remaining elements of the system 300 are not depicted but would be apparent to a person of skill in the art. The controller 330 may be any of the controllers discussed above and may be responsible for controlling the mass analysis instrument 100 and/or the sample delivery system 101 as well.

As shown in FIG. 3, the ESI source 314 can include a source 336 of pressurized gas (e.g., nitrogen, air, or a noble gas) that supplies a high velocity nebulizing gas flow to the nebulizer probe 338 that surrounds the outlet end of the electrospray electrode 316. As depicted, the electrospray electrode 316 protrudes from a distal end of the nebulizer probe 338. The pressured gas interacts with the liquid discharged from the electrospray electrode 316 to enhance the formation of the sample plume and the ion release within the plume for sampling by mass analyzer detector 320, e.g., via the interaction of the high-speed nebulizing flow and jet of liquid sample (e.g., analyte-solvent dilution). The liquid discharged may include discrete volumes of liquid samples LS received from each reservoir 310 of the well plate 312. The discrete volumes of liquid samples LS are typically separated from each other by volumes of the solvent S (hence, as flow of the solvent moves the liquid samples LS from the OPI 304 to the ESI source 314, the solvent may also be referred to herein as a transport fluid). The nebulizer gas can be supplied at a variety of flow rates, for example, in a range from about 0.1 L/min to about 20 L/min, which can also be controlled under the influence of controller 330 (e.g., via opening and/or closing valve 340).

It will be appreciated that the flow rate of the nebulizer gas can be adjusted (e.g., under the influence of controller 330) such that the flow rate of liquid within the sampling OPI 304 can be adjusted based, for example, on suction/aspiration force generated by the interaction of the nebulizer gas and the analyte-solvent dilution as it is being discharged from the electrospray electrode 316 (e.g., due to the Venturi effect). The ionization chamber 318 can be maintained at atmospheric pressure, though in some examples, the ionization chamber 318 can be evacuated to a pressure lower than atmospheric pressure.

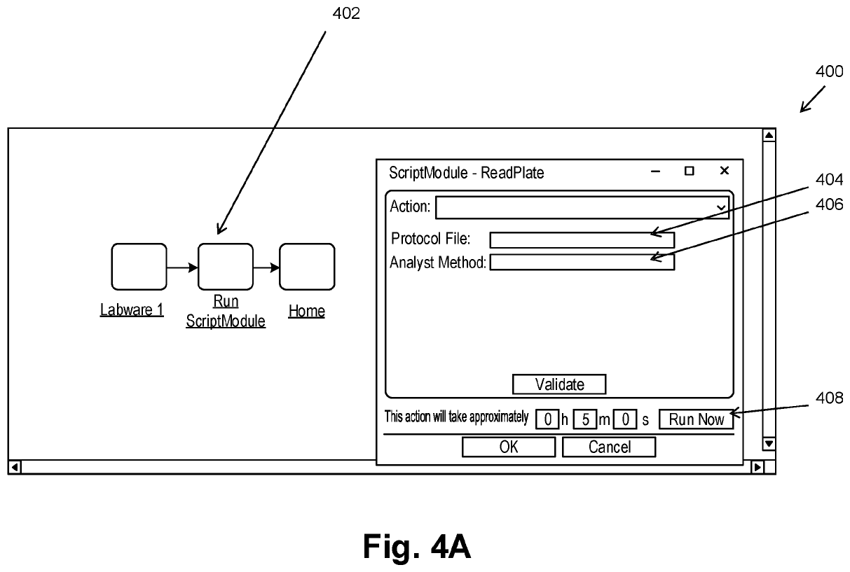

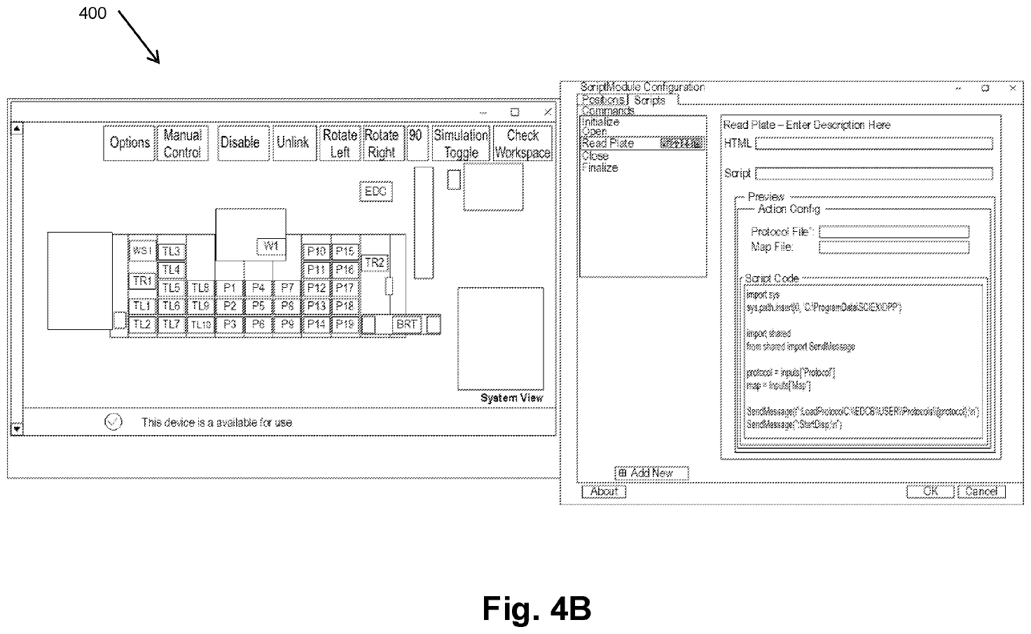

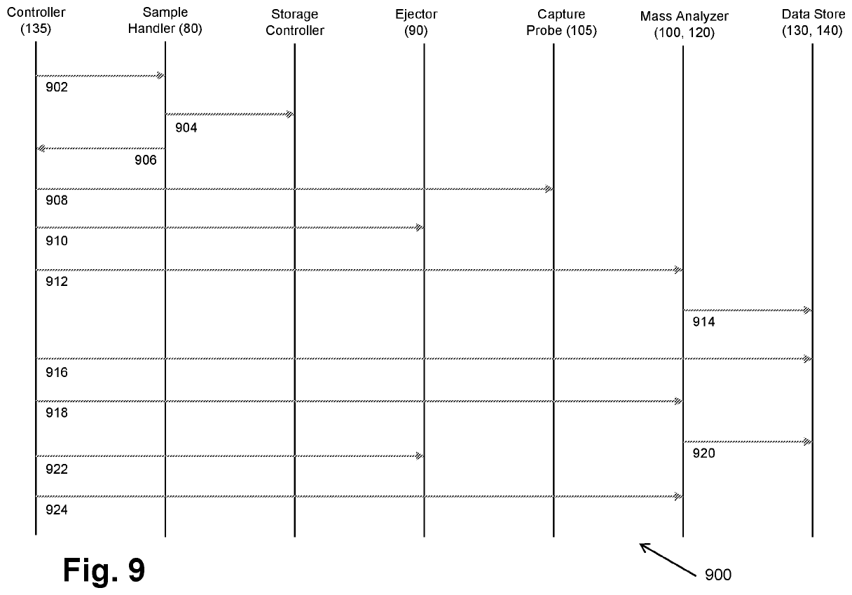

FIG. 4A illustrates a user interface 400 generated by control logic associated with, for example, a Biomek Installer Tool for controlling the operation of a sample handler 80 such as a Biomek robot to transfer sample well plates 75 from a well plate source, such as a sample or fluid handler 80, to a capture location. While any suitable control software may be used to control the components, such as the sample handlers, ejectors, etc., the example interfaces 400 were generated using an EDC Script Module for use in controlling the EDC embedded computer to manage receiving the well plates 75, and moving the stage 95 to locate selected samples on each well plate 75 proximate to a capture surface of a capture probe 105. The pattern of locating performed by the stage 95 may vary from well plate to well plate depending upon requirements. The control software (e.g., EDC Script Module or other suitable control software) may also be used to control frequency and volume of ejection by the ejector. Accordingly, the script module can be used to program a set of operations to be performed by the components of the respective systems, such as the mass analysis instrument 100, the sample preparation/delivery system 101, and/or the ejection system 102. Additional details regarding the particular fields of the user interface 400 are discussed further below with respect to FIG. 9.

FIG. 4B illustrates an embodiment of a user interface 450 for selecting and initiating a method of analysis to be executed on a plurality of samples. In various aspects and embodiments, the method may include iteratively selecting a specified number and location of samples within a single well plate 75 or a plurality of well plates 75 for ejection, capture, dilution, and analysis.

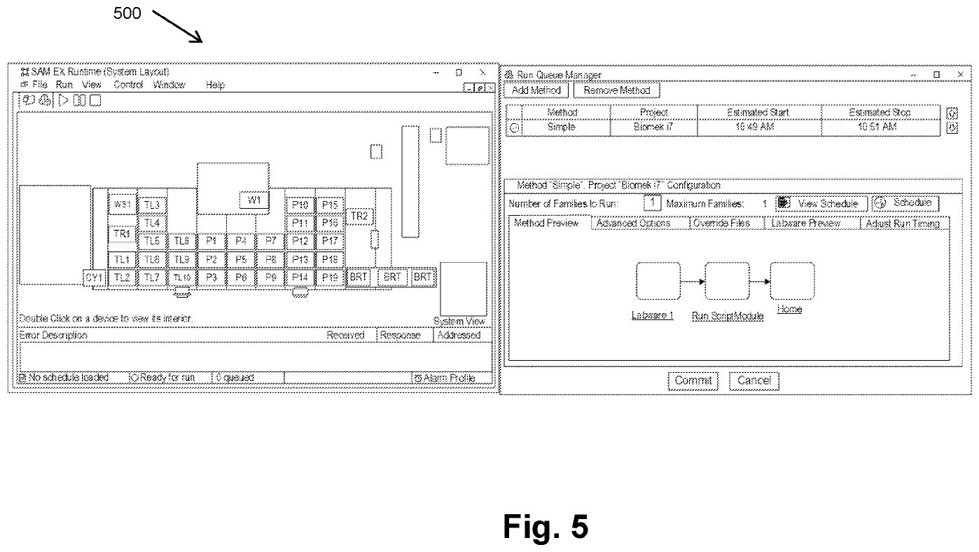

FIG. 5 illustrates user interface 500 adapted for control of a sample handler 80 for managing operation of the system 1000. In particular, a plurality of sets of samples may be provided in the form of a plurality of sample plates 75, each well plate 75 containing a plurality of samples. The sample plates may be managed in coordination with the system as disclosed herein. In aspects, such coordination may include associating at least one analysis instruction with each of the sample plates and coordinating components of the system in accordance with the associated at least one analysis instruction, for example through the use of identifiers associated with the samples and ready by the sample handler controller 80 through the use of machine vision techniques.

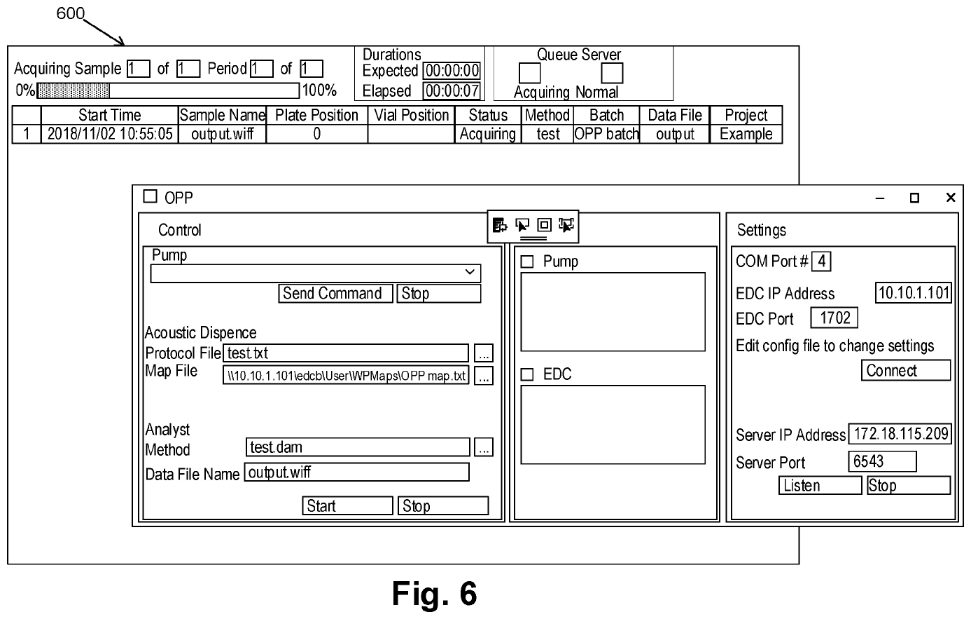

FIG. 6 illustrates a user input or interface adapted for inputting instructions to a controller for a capture probe 105. Such a user interface may for example be generated and controlled by a mass analysis instrument controller 135 as described herein.

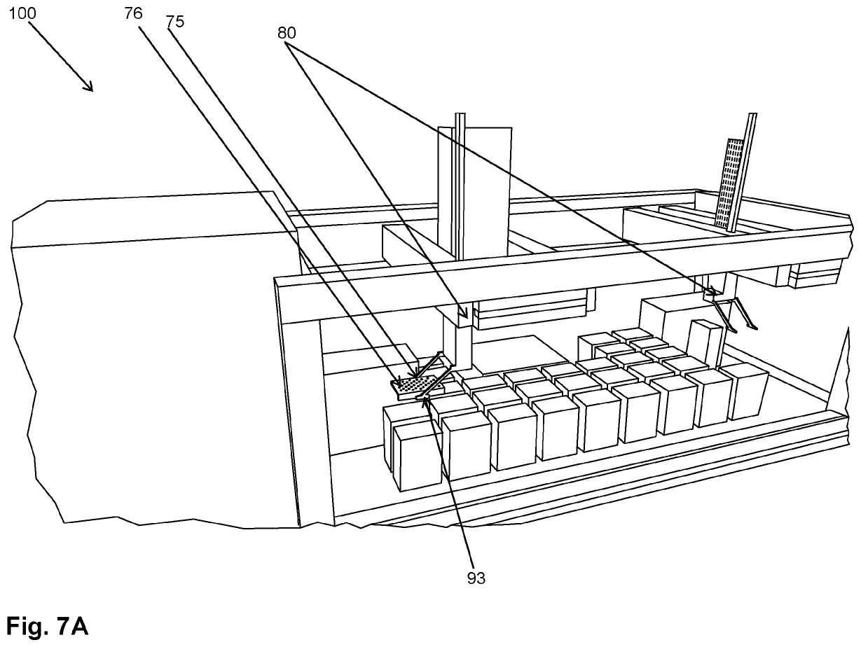

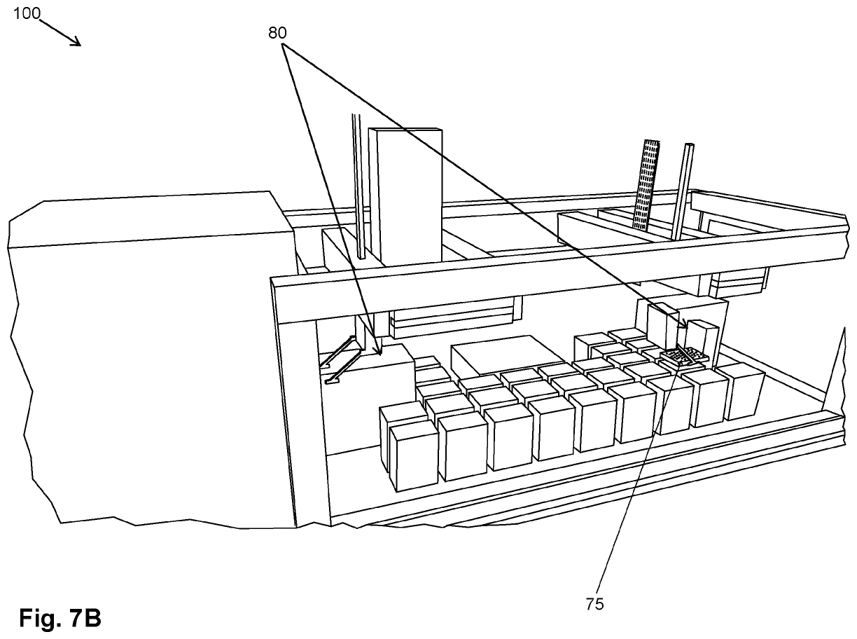

FIGS. 7A and 7B are rendered drawings illustrating a combination of a liquid handler acting as a sample source 70, a sample handler 80, e.g., a robot, for transferring each set of samples 76 (in this example each set comprises a sample well plate 75) within the liquid handling component and/or the sample preparation system 101. The sample handlers 80 may include plate grippers 93 to grip well plates.

While not depicted in FIGS. 7A-7B, an additional sample handler 80 (e.g., a robot arm and/or conveyor belt) may be utilized to transfer the well plate 75 from the sample preparation system 101 to the ejection system 102. For instance, the additional sample handler may grasp the well plate 75 and place it in the ejection system 102. When the well plate 75 is transferred from the sample preparation system 101 to the ejection system, the well plate 75 (or an identifier on the well plate) may be scanned by a reader, such as a barcode scanner located within the sample preparation system 101 and/or the ejection system. The information from the scanned identifier may be passed to the main controller and utilized for control of other elements, such as the mass analysis instrument 100. For instance, based on information received from scanning an identifier of a well plate in the sample preparation system, the controller 135 may cause settings or parameter changes in the mass analysis instrument 100 when the mass analysis instrument 100 is analyzing samples from the well plate 75 having the scanned identifier.

The well plate 75 is then ultimately transferred to the stage 95 and acoustic ejector 105 for locating and ejecting selected samples 76 from the transferred set of samples. When the well plate 75 has been analyzed, the same (or different) additional sample handler 80 may remove the sample from the ejection system. Effectively, to remove the well plate 75, the operations of the sample handler 80 may be reversed from those used to transfer to the well plate 75 to the ejection system. In other examples, however, the same sample handler may move the well plate 75 throughout the sample preparation system 101 and into the ejection system 102. In FIG. 7A, the sample handler 80 is retrieving a set of samples from the liquid handler. In FIG. 7B, the sample handler 80 is depositing a set of samples 76 on a sample plate 75 at a location for further processing or sample preparation, such as heating, cooling, mixing, fluid addition, etc.

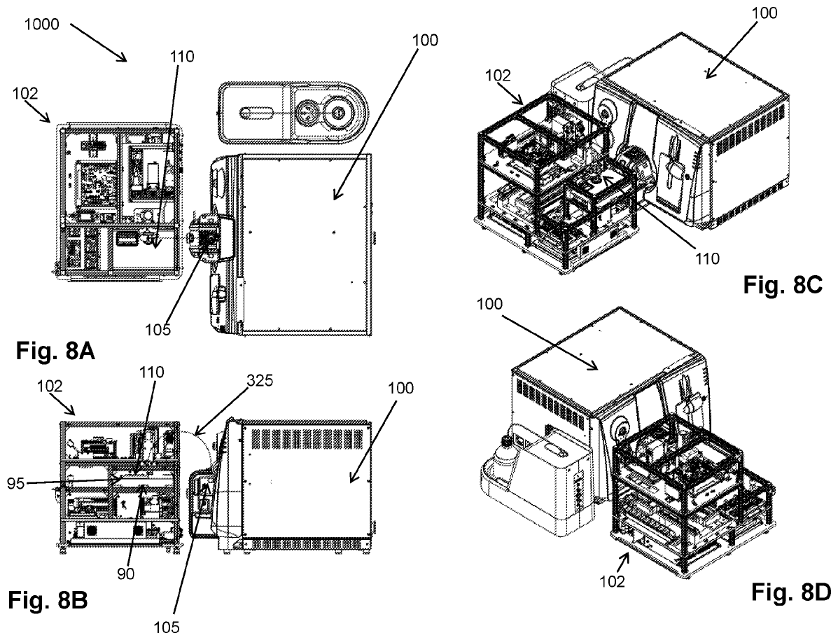

FIGS. 8A-8D are schematic diagrams of a portion of an example system 1000 from various points of view. In the embodiment shown, system 1000 includes an ejection system 102 and mass spectrometer (MS) 100. The ejection system 102 includes a movable stage 95 and an ejector 90. A well plate 75 may be received by the ejection system 102 and moved by the movable stage (and/or other electromechanical sample handling devices, such as tracks, conveyor belts, etc. in the ejection system 102) to position the well plate in a capture location 110, such as a location that is suitable for ejecting samples in the well plate 75 into a capture probe 105. The conduit 325 for transporting the sample to the MS 100 is also depicted in FIGS. 8A-8B. A machine reading device (not depicted), such as a barcode scanner or other optical scanner, may also be incorporated to read an identifier of the well plate 75. As discussed above, the MS 100 and the ejection system 102 are controlled by the same controller. The controller may control the electromechanical operations of the ejection system 102 along with the electromechanical and data analysis operations of the MS 100.

In accordance with various embodiments, instructions configured to be executed by a processing element to perform methods, and/or to render the system 1000 operative to carry out methods, in accordance with the disclosure can be stored on non-transitory computer-readable media accessible to the processing element.

Examples of such methods can be explained through reference to the figures. For example, starting with the signal exchange diagram shown in FIG. 9, a process of moving a collection of samples 76 on a microplate or well plate 75 from a sample source 70 to a capture location 110 for individual dispensing for group or individual analysis by a mass analysis instrument 100 can be described.

At 902 in FIG. 9 such an example method can begin with accessing, by an operator of a mass analysis system 1000, of one or more interactive user interfaces 400, 450, 500, 600 such as those shown in FIGS. 4-6, generated for a touchscreen or other display associated with a controller 135. By using a combination of graphical input devices, such as one or more mouses, trackballs, cursor direction keys, or pointing devices, and/or keyboards and touchscreens, for communicating graphical user interface information and command selections to the controller 135, such a user can for example use one or more program icons 402 (FIG. 4) to invoke one or more analysis applications or programs to specify both one or more operational protocols 404, 406 to be applied with respect to one or more desired samples or sample collections 76, and by selecting a ‘start’ icon such as ‘run now’ icon 408 can cause controller(s) 135 to initiate semi- or fully-automatic analysis processes. Optionally, as shown for example in FIGS. 4-6, the operator can be enabled to monitor and optionally manually intervene in such analysis processes as the processes occur.

Selection by such an operator of a start command icon 408 can, for example, cause a controller 135 at 902 to generate a sample retrieval signal configured to cause a sample handler 80 to retrieve one or more specified microplates 75 from a sample source 70 and ultimately have the microplate 75 delivered to a capture location 110, for selection and analysis of one or more specified samples.

At 904, on receipt of a sample retrieval signal, the sample handler 80 can poll one or more storage controllers of the sample source 70 for identifiers associated with locations at which the selected sample(s) can be retrieved, such as for example locations at which one or more corresponding microplates 75 can be retrieved.

Upon receipt of suitable location information, the sample handler 80 can cause suitably configured mechanical apparatus, such as for example one or more sets of plate grippers 93 (FIGS. 7A, 7B) to retrieve corresponding microplates 75 with the identified sample collection(s) from either or both of robotic arms and human operators for plate loading and unloading. Loading and unloading of the microplates 75 may be performed through one or more electromechanical devices. For instance, a first robotic device may remove the microplates from storage in the sample source 70, a second robotic device may transfer the microplate 75 to the ejection system, and a movable stage 95 may move the microplates to the capture location where samples can be ejected from the microplates.

As will be appreciated, the use of labels and/or other physical and/or virtual machine readable identifiers, or indicia, associated with individual samples 76 and/or well plates 75 can be used to automate some or all of the process used by any or all of sample handler 80, storage controllers, ejector 90, capture probe 105, and/or mass analysis instrument 100 to deliver and subsequently analyzed sample(s) provided through process(es) 900.

When the desired sample collection(s) are in place in capture location 110, at 906 sample handler 80 can transmit or route a suitably configured confirmation to the responsible controller 135.

On receipt at 906 that the sample collection is in a suitable capture location 110, at 908 the controller 902 can route or transmit to a capture probe 105 any placement commands suitable for causing the capture probe 105 to be placed in an appropriate position for capturing the desired sample(s) 76 upon ejection from the well plate 75. For example, such a command can be adapted to move the probe 105 up or down along a Z-axis into a desired position above the microplate 75, or otherwise place it at a desired position from which it can appropriately collect ejected droplets from one or more wells of the microplate 75.

When the capture probe 105 is suitably disposed relative to the well or collection plate 75, at 910 the controller 130 can route or transmit to a sample ejector 90, such as an acoustic ejector, a sample ejection command configured to cause the ejector to eject the sample, or a portion thereof, such as a droplet, from the well for collection by the capture probe 105. For example, an acoustic ejector 105 can use radio-frequency (RF) energy to generate sound through use of a transducer focus assembly (TFA), which enables generation of focused ultrasound pulses near the surface of a specified sample in a collection plate and thereby cause a sample droplet of desired volume to be raised above the surface for capture.

When a sample of a desired collection has been ejected, at 912 the controller 135 can generate and transmit or route to a mass analysis instrument 100 an analysis command signal representing instructions configured to cause the analyzer to perform any desired mass analysis, using for example known mass analysis techniques. For example, any desired dilutants, solvents or other substances may be added, and the sample may be ionized, and then subjected to any desired analysis through use of suitable mass analysis components and systems. As one example, a delivery solvent (i.e. methanol) can be pumped into the instrument from a solvent bottle by a gear pump; a degasser may be used to remove any undesired air gaps or bubbles from the solvent line so as to maintain the accurate and consistent solvent flow, an open-port injector (OPI) can generate a suitably balanced and consistent vortex to dissolve and extract the sample, and a consistent gas flow can be generated by ion source probe and electrode to pull the customer sample from the OPI into mass analysis instrument 100 for analysis.

Using any suitable mass analysis techniques, including for example known mass spectrometry techniques, at 914 the mass analyzer can generate and capture data representing the content of an analyzed sample, and store such data in temporary or persistent memory, including for example one or more data stores 130, 140. Such data can, for example, be generated, sorted and otherwise processed, and stored in memory(ies) 130, 140 by the mass analysis instrument 100, and/or at 916 controller(s) 130, 135 can semi- or fully-automatically control such processing, and/or an operator of the system 1000 can manually control such processing through the use of suitably-configured interface screens 400-600 as shown in FIGS. 4-6.

Thus it may be seen that, for example, the disclosure provides systems 1000 for analyzing collections 75 of substance samples 76, the systems comprising at least one of each of sample handler(s) 70, 80, 95, sample capture device(s) 90, 105; mass analysis instrument(s) 100, and controller(s) 130, 135, 145, the controller(s) being operative, in accordance with instructions received from at least one of an operator input device or user interface 300, 400, 500 and suitably machine-interpretable instructions stored in memory(ies) accessible by the controller, to generate signals configured to cause the sample handler 70, 80, 95 to collectively retrieve from a sample source 70 a plurality of samples 76 of one or more substances, and deliver the plurality of collected samples to the at least one sample capture device 90, 105; cause the sample capture device(s) 90, 105 to independently capture at least one of the collectively retrieved samples delivered by the sample handler(s) 70, 80, 95, and transfer the at least one captured sample to a mass analysis instrument 100; and cause the mass analysis instrument 100 to ionize and detect one or more particles of the transferred treated sample.

It will further be seen that sample capture device(s) 90, 105 in accordance with such aspects and embodiments can be configured, in accordance with signals generated by the at least one controller 130, 135, 145, to add to the at least one independently captured sample at least one of a dilutant and a solvent, prior to transferring the at least one captured sample to the mass analysis instrument 100.

It may further be seen that in various aspects and embodiments the disclosure provides such systems 1000 in which at least one of a plurality of collected samples 76 can be associated with an identifier interpretable by the controller 130, 135, 145, by example through use of a machine reading device 65 such as a bar code or QR code reader, and configured to enable the controller to generate signals configured for causing at least one component 70, 80, 90, 95, 105, 100 of the system 1000 to perform at least one sample capture, sample transfer, dilution, dissolution, or mass analysis operation specific to the sample associated with the identifier.

It will be seen that in many such aspects and embodiments, the controller(s) 130, 135, 145 are capable or adjusting any one or more operational settings of the mass analysis instrument, including for example sample identity, dilution parameters, ionization parameters, and spectrographic analysis parameters, as well as processes for generating and storing spectrographic data, based upon one or more analysis instructions associated with the at least one identifier. In other words, in some embodiments the at least one identifier is associated with data representing a plurality of analysis instructions, and at least one of the plurality of analysis instructions is associated with a subset of the plurality 76 of samples, and the controller 130, 135, 145 is operative to perform at least one of the sample capture, sample transfer, dilution, dissolution, or mass analysis operations based on at least one of the plurality of analysis instructions while the sample capture probe 90, 105 is capturing one of the subset of the plurality of samples.

It will also be seen that in various embodiments the sample capture probe 105 may include at least one sample ejector 90, which may be configured to independently eject a selected sample from the plurality 76 of samples for capture by the sample capture probe; and may include a sample staging device 95 operative to position a next-selected sample 76 for ejection by the sample ejector 105 subsequent to capture by a capture probe 105 of a previously-selected sample, so that samples may be continually analyzed by mass analyzer 100. For example, as shown in FIG. 9, at 918 a controller 130, 135, 145 can route to any or all of a sample handler 80, a storage controller 95, and/or a capture probe 105 a second command to select and retrieve a next-selected sample 76, cause it to be ejected, captured, and analyzed, and corresponding analysis data to be stored in data store 130, 140 at 920.

The feature of configuring a sample ejector 90 to eject a next-selected sample 76 subsequent to capture by a capture probe 105 of a previously selected sample, so that samples may be continually analyzed by mass analyzer 100, is one example of the particular advantages offered by systems in accordance with the invention. Using such a feature enables rapid analysis of multiple samples, which may or may not be analytically related. Such samples may, for example be multiple samples of a single substance; or they may be entirely unrelated in origin, method, and/or purpose of analysis.

In further embodiments, the invention provides systems 1000 comprising sample capture probes 105 comprising at least one sample ejector 90, which may be configured to eject a plurality of selected samples before positioning a next sample relative to the sample ejector. The feature of configuring a sample ejector 90 to eject multiple droplets of a single sample is an example of the particular advantages offered by systems in accordance with the invention. Using such a feature enables, for example, the use of multiple analysis methods, protocols, or parameters to be used in testing a single sample, or to apply a single analysis method, etc., to a single, relatively highly heterogenous sample. For example, at 922 in FIG. 9 a controller 130, 145, can route to an ejector 90 a second ejection command, prior to instructing a sample handler 80 to reposition a sample plate 75 or to retrieve a second sample tray, in order to cause the ejector 90 to eject one or more second or subsequent droplets of the same selected sample, and at 924 one or more commands to a mass analyzer 100, 120 to analyze the samples.

It will be further seen that in some embodiments, a single controller 130, 135, 145, etc., is operative to coordinate both a sample ejector 90 and a capture probe 105; or to control any or all of a sample source 70, sample handler 80, ejector 90, stage 95, probe 105, and analyzer 100, 115, 120, 125.

It will further be seen that the invention provides systems 1000 useful for analyzing pluralities of samples 76. Such a system can, for example, comprise one or more sample handlers 80 for retrieving a collection of samples from a sample source 70 and delivering the collection of samples to a capture location 110; a stage device 95 for receiving selected ones of the plurality of samples at the capture location 110 and locating or positioning a selected set of the samples in a capture position or capture location 110 proximate to a capture probe 105; one or more sample ejectors 90 for independently ejecting at least one of the selected set of samples into the capture location for capture by the capture probe 105. Such capture probe(s) can be configured to capture ejected sample(s) and dilute and transport them to mass analysis instrument(s) 100. Mass analysis instrument(s) 100 can be operative, for example through use of ion source(s) or generator(s) 115 produce sample ions and to filter and detect selected ions of interest from the sample ions; and, controller(s) 130, 135, 145 operative to coordinate operation of the sample handler(s) 80, stage device(s) 95, sample ejector(s) 90, capture probe(s) 105, and mass analysis instrument(s) 100, 115, 120, 125.

It will be seen that in any or all of the above embodiments, a controller 130, 135, 145 can be operative to maintain timed records, so that ejected samples 76 captured by capture probe 105 can be associated corresponding analysis results generated by the mass analysis instrument. For example, time/date stamp data can be generated and saved in association with time of any or all of retrieval, ejection, capture, and analysis.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a processor, a microprocessor, a programmable computer or an electronic circuit. In some embodiments, some one or more of the most important method steps may be executed by such an apparatus.

Generally, embodiments of the present invention can be implemented through the use of computer program products with program codes, the program codes being operative for performing the operations described herein when the computer program product runs on a computer such as may be used to embody any or all of controllers 130, 135, 145, etc.

While particular embodiments of the various aspects of the invention have been illustrated and described, it would be apparent to those skilled in the art that various other changes and modifications can be made and are intended to fall within the spirit and scope of the present disclosure. Furthermore, although the present disclosure has been described herein in the context of particular implementations in particular environments for particular purposes, those of ordinary skill in the relevant arts will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

1-10. (canceled)

11. A system for analyzing collections of substance samples, the system comprising:
a first sample handler;
a second sample handler;
a third sample handler;
an ejector;
a mass analysis instrument; and
a controller operative to, in accordance with instructions stored in memory accessible by the controller, generate signals configured to:
cause the first sample handler to retrieve a well plate from a sample source;
cause the second sample handler to transfer the retrieved well plate to an ejection system;
cause the third sample handler to position the transferred well plate in a capture location;
cause the ejector to eject a first sample from the well plate in the capture location; and
cause the mass analysis instrument to ionize and detect one or more particles of the ejected first sample.

12. The system of claim 11, wherein the controller is further operative to generate signals configured to:
cause the third sample handler to move the well plate to a new position;
cause the ejector to eject a second sample from the well plate; and
cause the mass analysis instrument to ionize and detect one or more particles of the ejected second sample.

13. The system of claim 11, herein either or both of the first sample handler and the second handler is a robotic arm.

14. (canceled)

15. The system of claim 11, wherein the third sample handler is a movable plate stage.

16. The system of claim 11, further comprising a machine reading device, wherein the controller is further operative to generate signals configured to cause the machine reading device to read an identifier from the well plate.

17. The system of claim 16, wherein at least a portion of the instructions are based on the read identifier.

18. The system of claim 16, wherein the controller is operative to adjust at least one operational setting of the mass analysis instrument; based upon an analysis instruction associated with the at least one identifier.

19. A system for analyzing collections of substance samples, the system comprising at least one of each of:
a sample handler;
a sample capture device;
a mass analysis instrument; and
a controller, the controller operative, in accordance with instructions received from at least one of an operator input device and machine-interpretable instructions stored in memory accessible by the controller, to generate signals configured to:
cause the sample handler to collectively retrieve from a sample source a plurality of samples of one or more substances, and deliver the plurality of collected samples to the sample capture device;
cause the sample capture device to independently capture at least one of the collectively retrieved samples delivered by the sample handler, and transfer the at least one captured sample to a mass analysis instrument; and
cause the mass analysis instrument to ionize and detect one or more particles of the transferred sample.

20. The system of claim 19, wherein the sample capture device is configured, in accordance with signals generated by the at least one controller, to add to the at least one independently captured sample at least one of a dilutant and a solvent, prior to transferring the at least one captured sample to the mass analysis instrument.

21. The system of claim 19, wherein at least one of the plurality of collected samples is associated with an identifier interpretable by the controller and configured to enable the controller to generate signals configured for causing at least one component of the system for analyzing collections of pluralities of substance samples to perform at least one sample capture, sample transfer, dilution, dissolution, or mass analysis operation specific to the sample associated with the identifier.

22. The system of claim 21, wherein the controller is operative to adjust at least one operational setting of the mass analysis instrument, based upon an analysis instruction associated with the at least one identifier.

23. The system of claim 21, wherein the at least one identifier is associated with data representing a plurality of analysis instructions, and wherein one of the plurality of analysis instructions is associated with a subset of the plurality of samples, and wherein the controller is operative to perform at least one of the sample capture, sample transfer, dilution, dissolution, or mass analysis operation based on at least one of the plurality of analysis instructions while the sample capture probe is capturing one of the subset of the plurality of samples.

24. The system of claim 19, wherein the sample capture probe comprises a sample ejector.

25. The system of claim 19, wherein the sample capture probe comprises a sample ejector configured to independently eject a selected sample from the plurality of samples for capture by the sample capture probe.

26. The system of claim 25, further comprising a sample staging device for positioning the selected sample for ejection by the sample ejector.

27. The system of claim 26, wherein the sample staging device is further operative to position a next selected sample for ejection by the sample ejector and optionally wherein the controller is further operative to coordinate the ejector to eject a plurality of selected samples before positioning a next sample relative to the sample ejector.

28. (canceled)

29. A system for analyzing a plurality of samples, the system comprising:
a sample handler for retrieving a collection of samples from a sample source and delivering the collection of samples to a capture location;
a stage device for receiving the plurality of samples at the capture location and locating a selected set of the samples in a capture position proximate to a capture probe;
a sample ejector for independently ejecting at least one of the selected set of samples into the capture surface for capture by the capture probe;
the capture probe for capturing the ejected sample and diluting and transporting the captured sample to a mass analysis instrument;
the mass analysis instrument operative to ionize the transported diluted sample to produce sample ions and to filter and detect selected ions of interest from the sample ions; and,
a controller operative to coordinate operation of the sample handler, stage device, sample ejector, capture probe, and mass analysis instrument.

30. The system of claim 29, wherein the controller is operative to maintain a timed record to associate an ejected sample captured by the capture probe with a corresponding analysis result generated by the mass analysis instrument.

31. The system of claim 29, the plurality of samples is associated with an identifier to enable the controller to apply at least one analysis instruction associated with the identifier when coordinating operation of the sample handler, stage device, ejector, capture probe, and mass analysis instrument.

32. The system of claim 31, wherein the controller is further operative to instruct the mass analysis instrument to apply a specified analysis operation corresponding to a selected sample based on the at least one analysis instruction and optionally wherein the controller is operative to coordinate the specified analysis operation with at least one sample positioning operation performed by the stage device.

33. (canceled)
